(19) United States
(12) Patent Application Publication
(10) Pub. No.: US 2021/0217260 A1
(43) Pub. Date: Jul. 15, 2021

(54) METHOD FOR UNLOCKING FINGERPRINT RECOGNITION LOCK AND ZIPPER LOCK WITH FINGERPRINT RECOGNITION

(71) Applicant: MICROPIXEL OPTRONICS CO., LTD., Taipei City (TW)

(72) Inventor: Hsin-Chung CHEN, Taipei City (TW)

(73) Assignees: MICROPIXEL OPTRONICS CO., LTD., Taipei City (TW); Hsin-Chung CHEN, Taipei City (TW)

(21) Appl. No.: 16/743,002

(22) Filed: Jan. 15, 2020

(51) Int. Cl. G07C 9/00; G06K 9/00; G07C 9/26; A45C 13/18; E05B 65/50

(52) U.S. Cl. CPC G07C 9/00563; G06K 9/00087; E05B 65/50; A45C 13/18; G07C 9/26

(57) ABSTRACT

Disclosed are a method for unlocking a fingerprint recognition lock and a zipper lock with fingerprint recognition. The fingerprint recognition lock includes a lock box and a movable locking plate detachably stacked on and locked by the lock box, and the movable locking plate has a fingerprint collection module or a fingerprint reader, and the lock box at a locked status maintains a power disconnection status. Only if a user presses the movable locking plate, the lock box will perform fingerprint collection or fingerprint recognition after power is supplied to the movable locking plate through a terminal supplying power. This disclosure has the effects of saving power and reducing the volume of the fingerprint recognition lock.

### FIELD OF INVENTION

The present disclosure relates to a method for unlocking a fingerprint recognition lock, and a zipper lock with fingerprint recognition, wherein a fingerprint collection/recognition module is installed onto a movable locking plate, and a power supply module is installed in a lock box, and if a user presses the movable locking plate, the power supply module in the lock box will start supply power to the movable locking plate to perform a fingerprint collection or recognition, so as to achieve the effects of saving power and reducing the volume of the fingerprint recognition lock.

### BACKGROUND OF INVENTION

### Description of the Related Art

In general, an object such as a suitcase, a briefcase, etc. comes with a zipper to prevent others from opening the objects at will, and a zipper lock is usually installed at an end of the zipper and a password or a key is provided for opening a lock box, so that after a zipper head zips up the zipper, a zipper plate of the zipper head can be locked by the lock box to achieve an anti-theft function and improve security.

With the advancement of science and technology, locks are also developed in a form of using fingerprint to unlock the locks, and a general fingerprint lock includes components such as a fingerprint reader, an electric lock, a battery, and a microprocessor, and these components are usually installed onto the lock box, so that the lock box installed on a surface of the object will occupy a specific volume and look less aesthetic. In addition, the power supply of the fingerprint lock must be maintained at a standby mode in order to supply power continuously, so that users can use the fingerprint reader anytime to unlock the fingerprint lock. However, the users may fall in an embarrassing situation of unable to unlock the fingerprint lock due to insufficient power.

In related prior arts, P.R.C. Pat. No. CN206822136U has disclosed a fingerprint lock having a fingerprint reader installed on a zipper plate, and there are two zipper plates, and one of the zipper plates has a fingerprint lock and a locking element installed thereon, and after the two zipper plates move towards each other, the zipper plate having the fingerprint lock can be locked onto the other zipper plate to achieve an anti-theft function. However, the zipper plate has the fingerprint reader, microprocessor, locking element, and battery installed thereon, so that the total volume becomes larger and the operation becomes inconvenient. On the other hand, the battery has to supply power to the fingerprint reader and the microprocessor installed on the zipper plate continuously in order to maintain the standby mode, and thus the issue of fast power consumption issue still cannot be solved.

Further, P.R.C. Pat. No. CN205884952U has disclosed another fingerprint lock having a fingerprint recognition plate installed onto a zipper plate, and components such as a fingerprint comparator, a battery, and a memory are installed on a purse, so as to achieve the anti-theft function. Although the fingerprint recognition plate is installed separately from the fingerprint comparator and the battery in this patented technology, the fingerprint recognition plate installed on the zipper plate has to use a conductive wire to electrically connect the battery and the fingerprint comparator in the purse in order to obtain electric power, so that when the zipper plate is moving along the zipper, the conductive wire will move with the zipper plate. As a result, the overall product assembling process becomes more complicated, and the cost becomes higher. Furthermore, the conductive wire may be broken or damaged easily, and this patented technology still cannot overcome the problem of supplying power to the battery continuously and improving the issue of fast power consumption.

### SUMMARY OF THE INVENTION

In view of the aforementioned drawbacks regarding to the volume and power supply of the conventional fingerprint recognition, this disclosure provides a method for unlocking a fingerprint recognition lock, characterized in that the fingerprint recognition lock comprises a lock box with a locking hook and a movable locking plate detachably stacked on and locked by the lock box, wherein the lock box has a push switch abutting against the movable locking plate, and a power supply module, and the movable locking plate has a fingerprint collection module or a fingerprint reader, and if the movable locking plate is stacked on and locked by the lock box, the movable locking plate will be electrically coupled to the lock box, and if a user presses the movable locking plate to conduct the push switch of the lock box, the power supply module of the lock box will supply power to the movable locking plate to perform a fingerprint collection or fingerprint recognition to unlock the fingerprint recognition lock. This disclosure can achieve the effects of reducing the volume of the movable locking plate and saving power.

This disclosure further provides a zipper lock with fingerprint recognition, and the zipper lock being installed to an object that uses a zipper to zip up and unzip the object, and comprising a movable locking plate and a lock box disposed at one of the ends of the zipper, and the movable locking plate being coupled to a zipper head that controls zipping and unzipping the zipper, and if the zipper head zips up the zipper, the movable locking plate will be detachably stacked on and locked by the lock box, wherein the movable locking plate has an inner side and an outer side, and a fingerprint collection module or a fingerprint reader is installed on the outer sides, and a contact terminal is installed on the inner side and electrically coupled to the fingerprint collection module or fingerprint reader, and a locking hole is provided for locking the lock box; the lock box has an outer surface, and a positioning portion is disposed on the outer surface and stacked on the inner side of the movable locking plate, and an elastic terminal is installed onto the positioning portion and contacted with the contact terminal of the movable locking plate, and a push switch abuts against the inner side of the movable locking plate inner side, and a locking hook is provided for locking into the locking hole; the lock box comprises a microprocessor installed therein for receiving a signal from the fingerprint collection module or the fingerprint reader through the contact of the contact terminal with the elastic terminal, a drive unit for receiving an instruction from the microprocessor to control the locking hook to unlock the zipper lock, and a power supply module electrically coupled to the elastic terminal and the push switch; thereby after the movable locking plate is pressed, the push switch will be conducted to drive the power supply module to start supplying electric power to the fingerprint collection module or the fingerprint reader of the movable locking plate through the elastic terminal and the contact terminal in order to perform a fingerprint collection or recognition, and then a signal is transmitted through the contact terminal and the elastic terminal to the microprocessor, and the microprocessor controls the drive unit to drive the locking hook to detach from the locking hole in order to unlock the zipper lock.

In an embodiment, the fingerprint collection module sends out a fingerprint feature data signal after collecting a fingerprint, and the microprocessor performs comparison and recognition after receiving the fingerprint feature data signal, and if the fingerprint is recognized as a correct fingerprint, the microprocessor will control the drive unit to drive the locking hook to unlock the zipper lock.

Alternatively, the fingerprint reader sends out an unlock signal after collecting a fingerprint and comparing and recognizing the collected fingerprint as the correct fingerprint, and the microprocessor controls the drive unit to drive the locking hook to unlock the zipper lock after receiving the unlock signal.

Compared with the prior art, this disclosure integrates the fingerprint collection/recognition function into the movable locking plate and integrates the power supply function into the lock box, and if it is necessary to collect/recognize a fingerprint, the push switch installed on the lock box will trigger the power supply module to start supplying power. This disclosure has the effects of reducing the volume of the fingerprint recognition zipper lock and saving power.

### BRIEF DESCRIPTION OF THE DRAWINGS

FIG. 1 is a perspective view showing an installation position of this disclosure;

FIG. 2 is an exploded view of this disclosure;

FIG. 3 is another exploded view of this disclosure viewing from another angle;

FIG. 4 is a schematic view showing an unlocked structure of a lock box and a movable locking plate in accordance with this disclosure;

FIG. 5 is a schematic view showing a locked structure of a lock box and a movable locking plate in accordance with this disclosure;

FIG. 6 is a schematic view showing a fingerprint collection/recognition of this disclosure;

FIG. 7 is a schematic view of using an external power supply for charging in accordance with this disclosure;

FIG. 8 is a schematic view of a sensing process conducted by an external sensor key of this disclosure; and

FIG. 9 is a schematic view of unlocking a lock after the sensing process conducted by the external sensor key of this disclosure.

### DESCRIPTION OF THE PREFERRED EMBODIMENTS

The present disclosure will become clearer in light of the following detailed description of an illustrative embodiment of this disclosure described in connection with the drawings, so that people having ordinary skill in the art can implement the present disclosure according to the description of this specification.

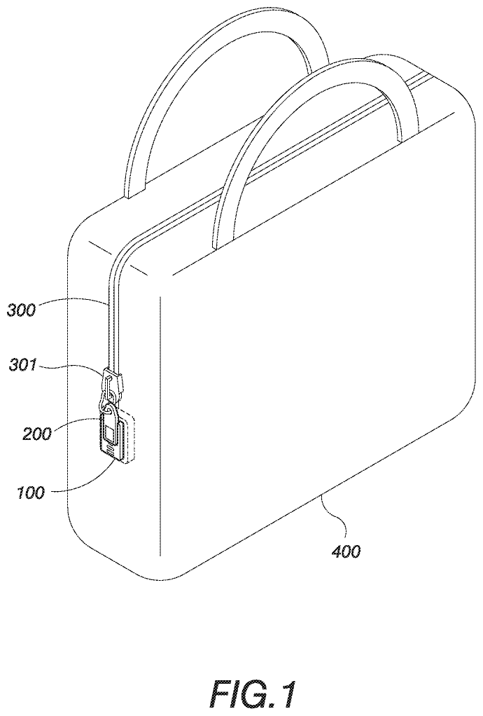

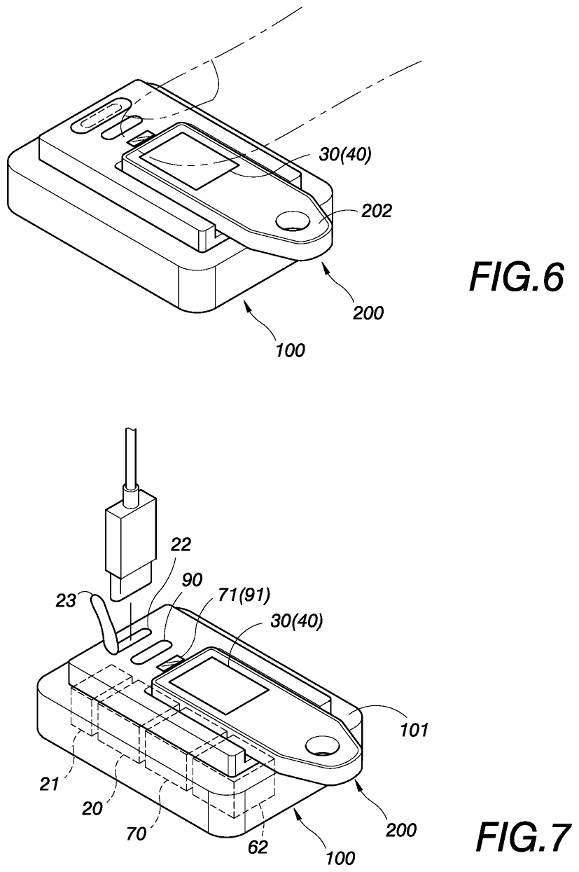

With reference to FIGS. 1 to 9, this disclosure is directed to a method for unlocking a fingerprint recognition lock, and the fingerprint recognition lock comprises a lock box 100, and a movable locking plate 200 detachably stacked on and locked by the lock box 100, wherein the lock box 100 has a push switch 10 a abutting against the movable locking plate 200, and a power supply module 20 for supplying power required for the operation of the fingerprint recognition lock, and the movable locking plate 200 has a fingerprint collection module 30 or a fingerprint reader 40.

The push switch 10 is normally maintained at a disconnection status to save power. When the movable locking plate 200 is stacked on the lock box 100 and locked by the lock box 100, the movable locking plate 200 and the lock box 100 are electrically coupled to each other. If a user presses the fingerprint collection module 30 or the fingerprint reader 40 of the movable locking plate 200, the user will also press the push switch 10 at the same time to achieve an electric conduction, so that the lock box 100 will start supplying power to the movable locking plate 200 to perform the fingerprint collection or fingerprint recognition in order to unlock the fingerprint recognition lock.

In an embodiment as shown in the figures, the fingerprint recognition lock is a zipper lock as shown in FIG. 1, and the zipper lock is installed on an object 400 that uses a zipper 300 and capable of using the zipper 300 to zip up and unzip the object 400, wherein the object 400 can be a suitcase, a briefcase, etc. In actual use, the fingerprint recognition lock of this disclosure can also be applied to any object that requires fingerprint for unlocking the object. For example, the movable locking plate 200 is installed on a door of a box body, and the lock box 100 is fixed to the box body.

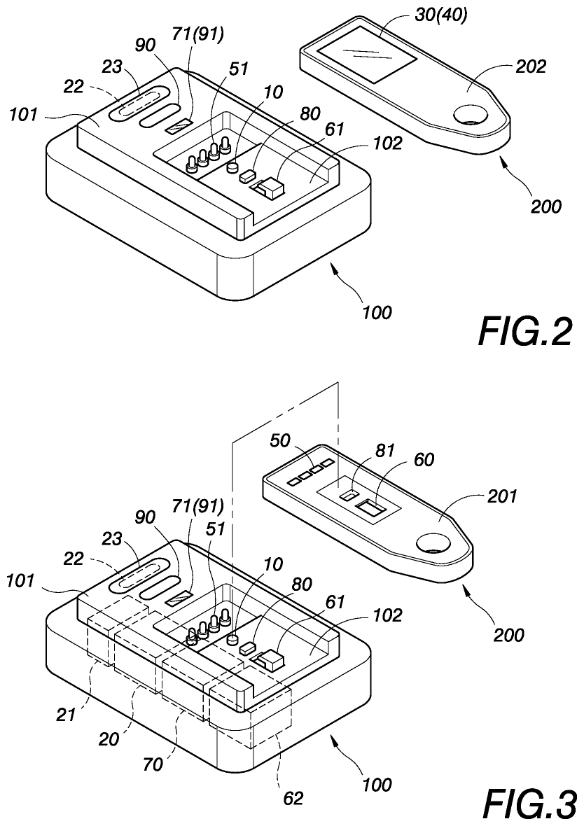

In the zipper lock with fingerprint recognition of this embodiment, the lock box 100 is installed at one of the ends of the zipper 300, and the movable locking plate 200 is coupled to a zipper head 301 that controls zipping and unzipping the zipper 300. When the zipper head 301 zips up the zipper 300, the movable locking plate 200 is detachably stacked on and locked to the lock box 100. In FIGS. 2 to 5, the movable locking plate 200 comprises an inner side 201, an outer side 202 with the fingerprint collection module 30 or the fingerprint reader 40 installed thereon, a contact terminal 50 disposed on the inner side 201 and electrically coupled to the fingerprint collection module 30 or the fingerprint reader 40, and a locking hole 60 for locking the lock box 100.

The lock box 100 has an outer surface 101, and the outer surface 101 has a positioning portion 102 stacked on the inner side 201 of the movable locking plate 200, wherein the positioning portion 102 is substantially in the same grooved shape as the outer contour of the movable locking plate 200, and the positioning portion 102 comprises the push switch 10 installed at the bottom thereof, an elastic terminal 51 capable of contacting the contact terminal 50 of the movable locking plate 200, and a locking hook 61 capable of locking into the locking hole 60. When the inner side 201 of the movable locking plate 200 is stacked on the grooved positioning portion 102, the push switch 10 abuts against the inner side 201 of the movable locking plate 200, and the outer side 202 of the movable locking plate 200 is substantially aligned precisely with the outer surface 101 of the lock box 100 to minimize the possibility of being collided by the movable locking plate 200.

The lock box 100 has a microprocessor 70 installed therein, a drive unit 62 for receiving an instruction of the microprocessor 70 to control the locking hook 61 to unlock the zipper lock, and also control the power supply module 20, wherein the power supply module 20 is electrically coupled to the elastic terminal 51, the push switch 10, the microprocessor 70 and the drive unit 62. After the push switch 10 is pressed, the power supply module 20 starts supplying power.

If the movable locking plate 200 is stacked on the positioning portion 102 of the lock box 100, so that the locking hole 60 is locked by the locking hook 61, the contact terminal 50 of the movable locking plate 200 will be electrically coupled to the elastic terminal 51 of the lock box 100.

In an embodiment, the locking hole 60 of the movable locking plate 200 is locked by the locking hook 61 of the lock box 100. With such arrangement, a user can press the push switch 10 while stacking the movable locking plate 200 on the positioning portion 102 of the lock box 100, so that the push switch 10 can be electrically conducted to drive the power supply module 20 to start supplying power. The microprocessor 70 controls the drive unit 62 to drive the locking hook 61 to move and lock the zipper lock. After the zipper lock is locked, the elastic terminal 51 or the push switch 10 maintains its resilience and abuts the inner side 201 of the movable locking plate 200 and resumes the push switch 10 to the original disconnection status, and the power supply module 20 will stop supplying power, and the locked status will be maintained.

In another embodiment, a general automatically resettable locking hook 61 is used, wherein the locking hook 61 is often abutted by an elastic element (not shown in the figure) and maintained at a locked position. When the movable locking plate 200 is stacked on the lock box 100, the locking hook 61 is pushed and squeezed for a displacement, and the locking hook 61 is abutted by the elastic element to restore its original position and automatically locked into the locking hole 60, so that the zipper lock can be locked without requiring any electric power. Similarly, the push switch 10 still maintains its disconnection status after the zipper lock is locked.

In order to align the locking hook 61 precisely with the locking hole 60 in an embodiment, a positioning column 80 and a positioning hole 81 are designed between the inner side 201 of the movable locking plate 200 and the positioning portion 102 and configured to be relative to each other, so as to assist the user to stack the movable locking plate 200 onto the positioning portion 102 of the lock box 100 accurately.

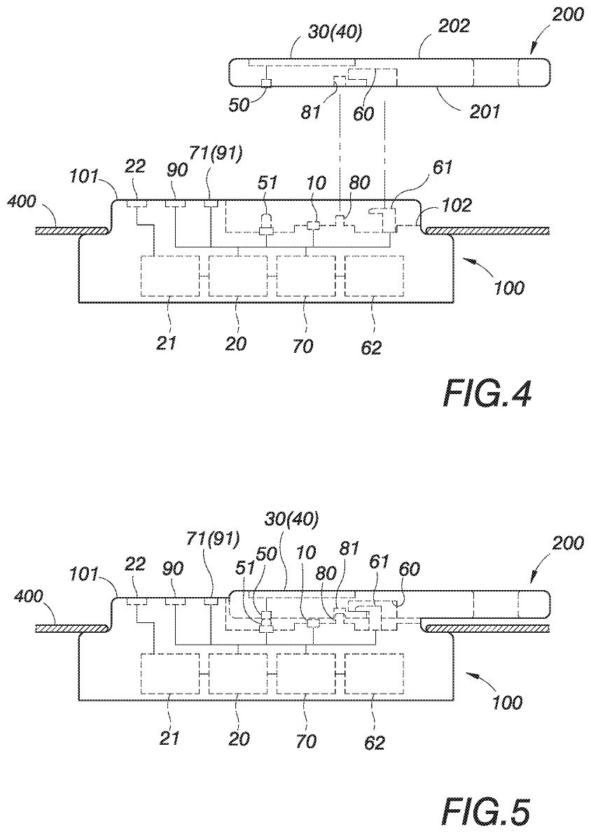

In FIGS. 4 to 6, when the user prepares to unlock the zipper lock and presses the fingerprint collection module 30 or the fingerprint reader 40 of the movable locking plate 200, the user also presses the push switch 10 at the same time for an electric conduction. Now, the power supply module 20 starts supplying power through the elastic terminal 51 and the contact terminal 50 to the fingerprint collection module 30 or the fingerprint reader 40 to perform fingerprint collection or recognition, and then a signal of a fingerprint characteristic collected by the fingerprint collection module 30 or the fingerprint reader 40 of the movable locking plate 200 or a fingerprint recognition result is transmitted through the contact terminal 50 and the elastic terminal 51 to the microprocessor 70. If the fingerprint characteristic or fingerprint recognition is matched with a correct fingerprint, then the microprocessor 70 will control the drive unit 62 to drive the locking hook 61 to detach the locking hole 60 and unlock the zipper lock. Therefore, the movable locking plate 200 can be separated from the lock box 100 to unzip the zipper. Further, after the movable locking plate 200 is separated from the lock box 100, the push switch 10 automatically resumes the disconnection status to achieve the effect of saving power.

In addition, the elastic terminal 51 can release the elastic force when the locking hook 61 is separated from the locking hole 60, so that the movable locking plate 200 can bounce from the positioning portion 102 of the lock box 100 to facilitate the user to apply force to the movable locking plate 200 in order to unzip the zipper. In an embodiment, an injector is installed between the inner side of the movable locking plate and the positioning portion of the lock box for assisting the detachment of the positioning portion after the movable locking plate unlocks the zipper lock, and this is one of the feasible solutions.

By the aforementioned method and structure of this disclosure, the fingerprint collection/recognition function is integrated with the movable locking plate 200, and the power supply function is integrated with the lock box 100. When it is necessary to collect/recognize a fingerprint, the push switch 10 installed on the lock box 100 triggers the power supply module 20 to start supplying power, so as to achieve the effects of saving power and reducing the volume of the fingerprint recognition zipper lock.

As described above, the movable locking plate 200 has the fingerprint collection module 30 or the fingerprint reader 40 installed thereon, and these two embodiments are slightly different in the unlocking process. In the embodiment of installing the movable locking plate 200 onto the fingerprint collection module 30, when the fingerprint collection module 30 sends out a fingerprint characteristic data signal to the lock box 100 through the elastic terminal 51 and contact terminal 50 after collecting a fingerprint, so that the microprocessor 70 of the lock box 100 can receive the fingerprint feature data signal for comparison and recognition. After a correct fingerprint is recognized, the microprocessor 70 controls the drive unit 62 to drive the locking hook 61 to unlock the zipper lock.

If the movable locking plate 200 is installed on the fingerprint reader 40, the fingerprint reader 40 is used directly for collecting and recognizing the fingerprint during the process of unlocking the zipper lock. After the fingerprint reader 40 recognizes the correct fingerprint, an unlock signal is sent out and transmitted through the elastic terminal 51 and the contact terminal 50 to the lock box 100. After the microprocessor 70 of the lock box 100 receives the unlock signal, the microprocessor 70 controls the drive unit 62 to drive the locking hook 61 to unlock the zipper lock.

In FIG. 7, the power supply module 20 comprises a chargeable/dischargeable battery 21, and a charging port 22 is installed on the outer surface 101 of the lock box 100 and electrically coupled to the battery 21, and a protective cover 23 is provided for covering the charging port 22, and an external power supply can be plugged into the charging port 22 for charging the battery 21. Therefore, the battery 21 can be charged through the charging port 22 to prevent the embarrassing situation of running out of the power of the battery 21 and failing to unlock the zipper lock.

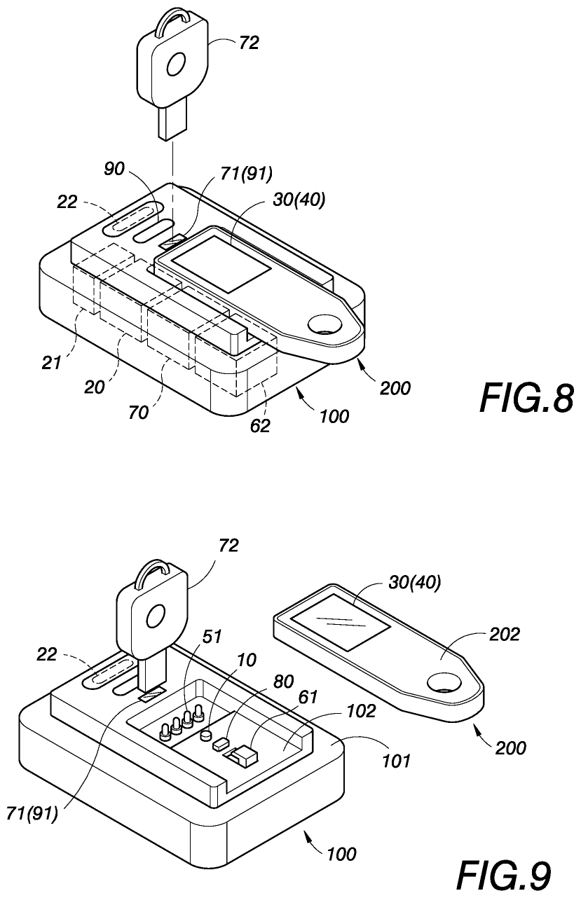

In FIGS. 8 and 9, a sensing unit 71 is further installed on the outer surface 101 of the lock box 100 and electrically coupled to the microprocessor 70, wherein the sensing unit 71 comprises an external sensor key 72, and after the external sensor key 72 and the sensing unit 71 sense each other, the sensing unit 71 can send out an unlock signal. After the microprocessor 70 receives the unlock signal, the microprocessor 70 controls the drive unit 62 to drive the locking hook 61 to unlock the zipper lock. The function of the external sensor key 72 is similar to a spare key, which can improve the practicality of the zipper lock and avoid a very special situation that the fingerprint collection module 30 or the fingerprint reader 40 cannot collect or recognize the fingerprint. In such case, the external sensor key 72 still can be used for unlocking the zipper lock.

In an embodiment as shown in FIGS. 2 and 3, the outer surface 101 of the lock box 100 further has a fingerprint setting key 90 for adding and deleting a fingerprint, and an indicating lamp 91 for displaying a status, wherein the fingerprint setting key 90 and the LED indicating lamp 91 are electrically coupled to the microprocessor 70. When a user adds or deletes a fingerprint by using the fingerprint setting key 90, the user can know whether or not the addition or deletion of the fingerprint is successful by the number of flashes of the LED indicating lamp 91. In an embodiment, the sensing unit 71 and the LED indicating lamp 91 can be installed individually or integrated into a same component as shown in the figures.

Based on the description above, there are two ways of either installing the fingerprint collection module 30 or the fingerprint reader 40 on the movable locking plate 200. When the user presses the movable locking plate 200, the push switch 10 is turned on to drive the power supply module 20 to start supplying power, and then the user continues to press the fingerprint setting key 90, so that the fingerprint collection module 30 can collect the fingerprint characteristics which are sent and stored to the memory of the microprocessor 70 of the lock box 100 through the elastic terminal 51 and the contact terminal 50. If the fingerprint reader 40 is installed on the movable locking plate 200, then the fingerprint reader 40 will save the new fingerprint into its memory.

While the present disclosure has been described by means of specific embodiments, numerous modifications and variations could be made thereto by those skilled in the art without departing from the scope and spirit of this disclosure set forth in the claims.

What is claimed is:

1. A method for unlocking a fingerprint recognition lock, the fingerprint recognition lock comprising a lock box with a locking hook and a movable locking plate detachably stackable on to and locked by the lock box, wherein the lock box has a push switch configured to abut against the movable locking plate, and a power supply module, and the movable locking plate has a fingerprint collection module or a fingerprint reader, the method comprising:
stacking the movable locking plate on to the lock box for locking engagement with the lock box, said stacking causing the movable locking plate to electrically coupled with the lock box,
in response to a user pressing the movable locking plate, the push switch of the lock box engaging to cause the power supply module of the lock box to supply power to the movable locking plate via said electrical coupling to perform a fingerprint collection or fingerprint recognition to unlock the fingerprint recognition lock.

2. A zipper lock with fingerprint recognition, installable on an object that uses a zipper to zip up and unzip the object, and comprising:
a movable locking plate, and
a lock box disposed at one of the ends of the zipper,
wherein:
the movable locking plate is disposed on a zipper head used for zipping and unzipping of the zipper, and when the zipper head zips up the zipper, the movable locking plate is then positioned to be detachably stacked on and locked by the lock box, wherein the movable locking plate comprises:
an inner side and an outer side,
a fingerprint collection module or a fingerprint reader disposed on the outer side,
at least one contact terminal installed on the inner side and electrically coupled to the fingerprint collection module or fingerprint reader, and
a locking hole configured for locking engagement with the lock box; and
wherein the lock box comprises:
an outer surface,
a positioning portion disposed on the outer surface and stackable with the inner side of the movable locking plate,
at least one elastic terminal disposed on the positioning portion and configured to make electrical contact with the at least one contact terminal of the movable locking plate,
a push switch configured to abut the inner side of the movable locking,
a locking hook configured for locking engagement with the locking hole;
a microprocessor installed therein for receiving a signal from the fingerprint collection module or the fingerprint reader through contact of the contact terminal with the elastic terminal,
a drive unit controllable by the microprocessor to control the locking hook to unlock the zipper lock, and
a power supply module electrically coupled to the elastic terminal and the push switch;
wherein pressing of the movable locking plate engages the switch to cause the power supply module to supply electrical power to the fingerprint collection module or the fingerprint reader of the movable locking plate through the elastic terminal and the contact terminal in order to perform a fingerprint collection or recognition, and then a signal is transmitted through the contact terminal and the elastic terminal to the microprocessor, and the microprocessor controls the drive unit to drive the locking hook to detach from the locking hole in order to unlock the zipper lock according to the signal.

3. The zipper lock with fingerprint recognition as claimed in claim 2, wherein the fingerprint collection module sends out a fingerprint feature data signal after collecting a fingerprint, and the microprocessor performs comparison and recognition after receiving the fingerprint feature data signal, and if the fingerprint is recognized as a correct fingerprint, the microprocessor will control the drive unit to drive the locking hook to unlock the zipper lock.

4. The zipper lock with fingerprint recognition as claimed in claim 2, wherein the fingerprint reader sends out an unlock signal after collecting a fingerprint and comparing and recognizing the collected fingerprint as the correct fingerprint, and the microprocessor controls the drive unit to drive the locking hook to unlock the zipper lock after receiving the unlock signal.

5. The zipper lock with fingerprint recognition as claimed in claim 2, wherein the power supply module comprises a chargeable and dischargeable battery, and the lock box further comprises a charging port disposed on an outer surface thereof, and electrically coupled to the battery, and configured to accept an external power supply to be plugged into the charging port to charge the battery.

6. The zipper lock with fingerprint recognition as claimed in claim 5, wherein the lock box further comprises a protective cover for covering the charging port.

7. The zipper lock with fingerprint recognition as claimed in claim 2, wherein the lock box further comprises an LED indicating lamp installed onto an outer surface thereof and provided for displaying a status, and a fingerprint setting key provided for adding and deleting a fingerprint, and the LED indicating lamp and the fingerprint setting key are electrically coupled to the microprocessor.

8. The zipper lock with fingerprint recognition as claimed in claim 2, wherein the lock box further comprises a sensing unit installed onto an outer surface thereof and electrically coupled to the microprocessor, and the sensing unit further comprises an external sensor key capable of unlocking the zipper lock.

9. The zipper lock with fingerprint recognition as claimed in claim 2, wherein the positioning portion of the lock box is substantially in a same grooved shape as an outer contour of the movable locking plate, and when the movable locking plate is stacked on and locked by the lock box, the outer side of the movable locking plate is substantially aligned with the outer surface of the lock box.

10. The zipper lock with fingerprint recognition as claimed in claim 2, further comprising a positioning column and a positioning hole disposed between the inner side of the movable locking plate and the positioning portion of the lock box and configured to be relative to each other.
